(19) United States
(12) Patent Application Publication
(10) Pub. No.: US 2006/0111050 A1
(43) Pub. Date: May 25, 2006

(54) Multi-antenna communication system employing improved signal calibration

(75) Inventors: Eun-Sun Choi, Gwachun-si (KR); Jang-Hoon Yang, Sungnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/286,217

(22) Filed: Nov. 23, 2005

(30) Foreign Application Priority Data
Nov. 23, 2004 (KR) 2004-0096106

(51) Int. Cl. H04B 17/00

(52) U.S. Cl. 455/67.11

(57) ABSTRACT

An apparatus and method for correcting phase and amplitude variations of a data signal caused by a non-linear system in a multi-antenna communication system. A BS adds a reference signal with a power level less than the power of the data signal to the data signal and accumulates the response of the non-linear system to the sum signal, estimates the variations in the phase and amplitude of the data signal, and calibrates the data signal using the estimate.

### PRIORITY

This application claims priority under 35 U.S.C. § 119 to an application filed in the Korean Intellectual Property Office on Nov. 23, 2004 and assigned Serial No. 2004-96106, the contents of which are incorporated herein by reference.

### BACKGROUND OF THE INVENTION

1. Field of the Invention

The present invention relates generally to a method and apparatus for correcting variations in the phase and amplitude of a signal in a multi-antenna communication system, and in particular, to a method and apparatus for correcting variations caused by a non-linear system in the phase and amplitude of a signal in an Orthogonal Frequency Division Multiple Access (OFDMA) communication system using a smart antenna. OFDMA communication system is a multi-carrier communication system.

2. Description of the Related Art

A smart antenna system refers to an adaptive antenna array used in mobile communication applications. As frequency efficiency has reached its limit in recent years, studies are being actively conducted to improve the quality of the mobile communication systems and develop systems suitable for high-speed data transmission.

Using a smart antenna system with a plurality of antennas, a base station (BS) receives a signal propagated from a mobile station (MS) or subscriber unit, while reducing the level of a noise signal arising from multiple access interference propagated from the other directions by controlling the gains and phases of the signals in the antennas.

Since every subscriber unit within the coverage area of the same BS receives interference from signals serving other subscriber units as well as a signal serving the subscriber unit, the signal-to-noise ratio (SNR) of the received signal is decreased. By contrast, the smart antenna technology actively locates a particular subscriber unit from among the subscriber units within the same BS area and applies directionality to a transmission/reception signal according to the location of the subscriber unit, thereby minimizing interference to the subscriber units located in the other directions.

Beamforming is a signal processing technique used to control the directionality of the reception or transmission of a signal in the smart antenna system. Beamforming is carried out in a baseband digital signal process in the BS. The resulting beams must reach antennas without variations in the phase and amplitude of the baseband signal, prior to radiation over the air. Yet the signal experiences phase and amplitude distortion due to a non-linear system including an amplifier, an up/downcoverter, a front-end unit (FEU), and a cable which show non-linearity in the BS. To compensate for the distortion, a signal calibration technique is used along with the smart antenna technology. The accuracy of signal calibration dominates the entire performance of the smart antenna technology. The performance of the smart antenna technology can be improved by increasing the accuracy of the directionality and minimizing a phase mismatch through signal calibration. The signal calibration applies to both downlink communications from a BS to a subscriber unit and uplink communications from the subscriber unit to the BS.

FIG. 1 is a diagram illustrating a signal flow for a conventional signal calibration method. Conventionally, signal calibration is carried out with the aid of a subscriber unit. A BS and a subscriber unit first exchange bursts and perform uplink and downlink signature estimation. The BS then calibrates a transmission path based on the estimated uplink and downlink signatures. To describe the calibration in more detail, the BS initiates a call with a subscriber unit. In FIG. 1, the call initiation occurs during a period described by CALL SETUP. The subscriber units transmit an uplink (UL) calibration burst to the BS and the BS transmits a downlink (DL) calibration burst to the subscriber unit. The BS and the subscriber unit each perform a signature estimation using the received burst. The subscriber unit reports the DL signature estimate to the BS. The BS estimates a transmission (Tx) path calibration vector using the UL signature estimate and the received DL signature estimate, and then terminates the call with the subscriber unit.

### SUMMARY OF THE INVENTION

Application of the conventional calibration method to an OFDMA system experiences the following problems. (1) Aside from a data signal, additional radio resources are needed to allocate a reference signal for calibration. (2) Since calibration is carried out in the BS not independently but with the aid of the subscriber unit, the computation volume of the subscriber unit increases. (3) As a subscriber unit is involved in calibration, a calibration protocol must be defined between all subscriber units and the BS. (4) The feedback of a DL signature estimate from the subscriber unit to the BS by a message requires resource allocation. Particularly in a multicarrier OFDMA system, the amount of the feedback information increases significantly.

An object of the present invention is to substantially solve at least the above problems and/or disadvantages and to provide at least the advantages below. Accordingly, an object of the present invention is to provide an apparatus and method for calibrating phase and amplitude variations of a data signal caused by a non-linear system in a smart-antenna communication system.

Another object of the present invention is to provide an apparatus and method for correcting phase and amplitude variations of a data signal caused by a non-linear system by combining a reference signal having a power level less than the power level of the data signal with the data signal and accumulating the response of the combined signal, in such a way as to perform signal calibration independently of a subscriber unit in a BS.

The above objects are achieved by providing an apparatus and method for correcting phase and amplitude variations of a data signal caused by a non-linear system in a smart-antenna multicarrier communication system.

According to one aspect of the present invention, in a smart-antenna communication system, a calibration processor transmits to a baseband module a reference signal at a power level less than a data signal power level, receives from a non-linear system a response signal to the input of the sum of the reference signal and the data signal, modulates the response signal, and calculates a calibration vector by estimating variations in the phase and amplitude of the data signal for each antenna using the reference signal and the response signal. The baseband module adds the reference signal to the data signal, transmits the sum to the non-linear system, calibrates a beamforming weight vector using the calibration vector received from the calibration processor, and forms a beam using the calibrated beamforming weight vector.

According to another aspect of the present invention, in a method of calibrating transmission data in a smart-antenna multicarrier communication system, a reference signal with a power level less than a power level of a data signal is transmitted to a baseband module, for use in estimating non-linear system-caused variations in the phase and amplitude of the data signal. The reference signal is added to the data signal, and the sum signal is transmitted to a non-linear system, after modulation. The response signal from the non-linear system to the sum signal is demodulated and accumulated. A calibration vector is estimated for the data signal to be transmitted through an antenna using the accumulated response signal. The data signal is calibrated using the estimated calibration vector.

According to a further aspect of the present invention, in a smart-antenna communication system, a calibration processor generates a reference signal with a power level less than a power level of a data signal using noise power estimated by a baseband module, transmits the reference signal to a non-linear system after modulation, and calculates a calibration vector by estimating variations in the phase and amplitude of the data signal for each antenna using the reference signal and the response signal from the non-linear system to the reference signal. The baseband module estimates the noise of a frame received just previous to a frame with which reception path calibration begins, provides the noise estimate to the calibration processor, provides the response signal from the non-linear system to the calibration processor, and calibrates a beamforming weight vector using the calibration vector received from the calibration processor.

According to still another aspect of the present invention, in a method of calibrating received data in a smart-antenna communication system, the power of a reference signal is determined to be less than the power of a data signal using an estimated of the noise power of a frame previous to a frame with which reception path calibration begins. The reference signal is modulated and transmitted to a non-linear system. The response signals from the non-linear system to the reference signal are accumulated and demodulated. A calibration vector is estimated for the data signal for an antenna using the demodulated response signal, and the data signal is calibrated using the estimated calibration vector.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a signal flow for a conventional signal calibration method; FIGS. 2A and 2B are block diagrams illustrating Tx path calibration and Rx path calibration in a smart antenna system, respectively;

FIG. 3 illustrates a reference signal transmission method according to an embodiment of the present invention;

FIG. 4 illustrates a reference signal transmission method according to another embodiment of the present invention;

FIG. 5 is a block diagram of a Tx path calibration apparatus according to an embodiment of the present invention;

FIG. 6 is a flowchart illustrating a Tx path calibration method according to the embodiment of the present invention; FIG. 7 is a block diagram of an Rx path calibration apparatus according to another embodiment of the present invention; and

FIG. 8 is a flowchart illustrating an Rx path calibration method according to the second embodiment of the present invention.

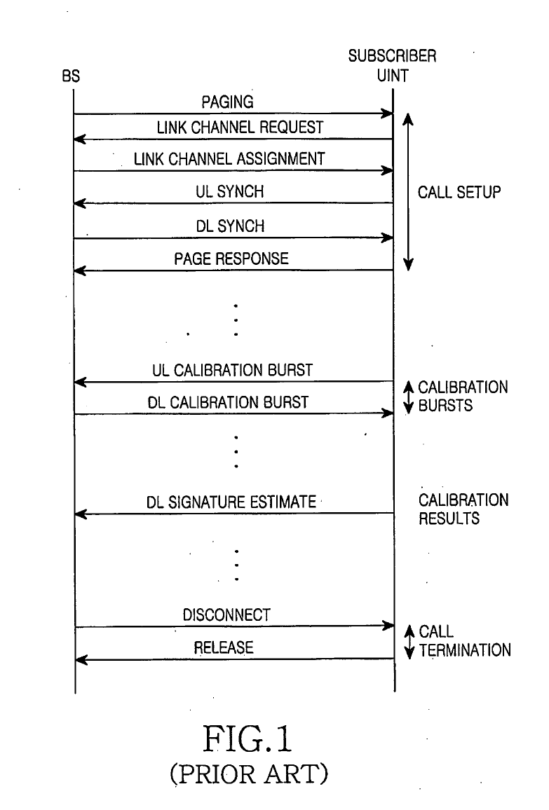

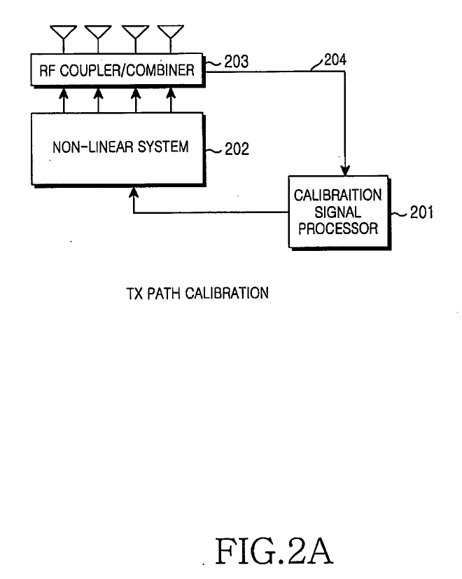

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide an apparatus and method for calibrating phase and amplitude variations of a data signal caused by a non-linear system in a smart-antenna multicarrier communication system. A BS uses a reference signal with a power level less than a power level of the data signal and accumulates the response of the combined signal. The BS then estimates and compensates the variations in the phase and amplitude of the data signal using the accumulated response. Therefore, the performance of the smart-antenna communication system is improved.

The present invention applies to a smart-antenna multicarrier communication system. An OFDMA communication system is used herein to describe the present invention, but it will be apparent to one skilled in the art that the present invention can be applied to other systems as well.

FIGS. 2A and 2B are block diagrams illustrating Tx path calibration and Rx path calibration in a smart antenna system, respectively.

Referring to FIG. 2A, for Tx path calibration, a reference signal generated from a calibration signal processor 201 in a digital signal processing area (channel card) is provided to a radio frequency (RF) coupler/combiner 203 through a non-linear system 202 including RF devices such as an amplifier and a converter, and an antenna cable. The RF coupler/combiner 203 transfers the received reference signal in a calibration Rx path 204. The calibration signal processor 201 utilizes the response of the reference signal in estimating the phase and amplitude variation of the reference signal caused by the non-linear system 202. This Tx path calibration is carried out for each antenna.

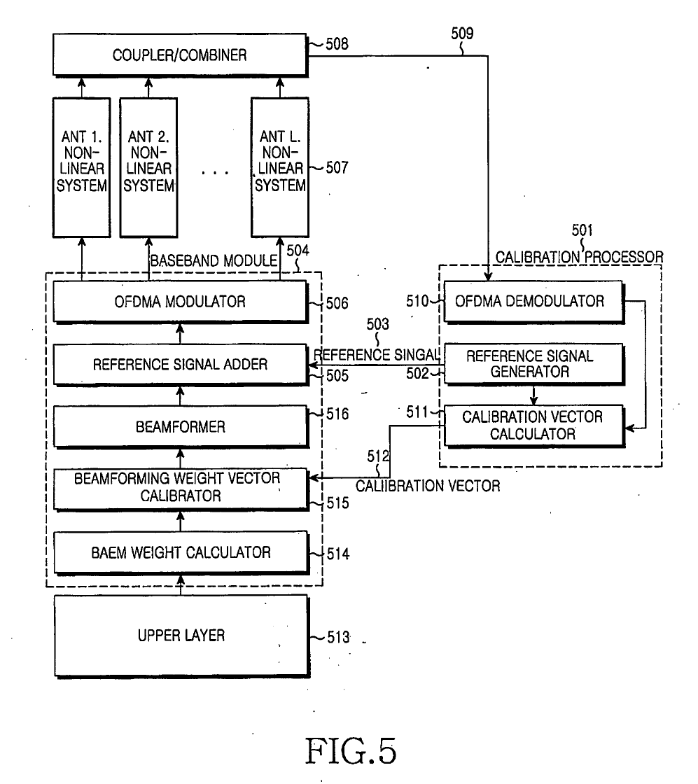

While not shown, a baseband module is interposed between the calibration signal processor 201 and the non-linear system 202 (see FIGS. 5 and 7).

Referring to FIG. 2B, for Rx path calibration, a reference signal generated from a calibration signal processor 205 is provided to an RF coupler/splitter 207 through a calibration Tx path 206. The RF coupler/splitter 207 adds the reference signal to traffic signals received separately at respective antennas, and retransmits the sum signals in an Rx direction. The retransmitted signals are provided to the calibration signal processor 205 through the non-linear system 208 and demodulated. The difference in the phase and amplitude of the reference signal in the Rx path of each antenna during this operation is estimated. This Rx path calibration is performed commonly for all antennas using one reference signal transmission.

While not shown, a baseband module is interposed between the calibration signal processor 205 and the non-linear system 208 (see FIGS. 5 and 7).

The OFDMA system estimates in the phase and amplitude variations of a signal caused by a non-linear system on a subcarrier-by-subcarrier basis. A reference signal is transmitted across a frequency band and a calibration vector is estimated for each antenna using the response of the reference signal. However, since the transmission of the reference signal over the frequency band may significantly affect a data signal, the reference signal having a power level less than the power level of the data signal is added to the data signal and the response of the sum signal is utilized in estimating the phase and amplitude variations. That is, the reference signal is transmitted at a lower level than the data signal to avoid the impact of the reference signal transmission on the data signal, and separately in a plurality of OFDM symbols in the total frequency band. In addition, to overcome problems that may result from the low power level of the reference signal leading to a low signal-to-interference ratio (SIR), the reference signal transmission is repeated, and a calibration vector estimate using an accumulated reference signal response improves estimation performance.

OFDMA is a multicarrier transmission scheme. In OFDMA, input data is converted into a number of parallel data streams equal to the number of subcarriers used and transmitted on the subcarriers. Therefore, a number of reference signal responses equal to the number of subcarriers used, N_{used}, are required for calibration. Since variations in phase and amplitude across the frequency band must be compensated for with respect to each antenna, the reference signal is transmitted across the frequency band.

Satisfying Equation (1), the reference signal is added to data on N_{perSym} subcarriers in each OFDMA symbol and transmitted at a power level less than the data signal power level by a factor of x dB in order to minimize the impact of the reference signal transmission on the data.
s·N_{perSym}=N_{used} (1)
where N_{perSym} denotes the number of subcarriers that deliver the reference signal in each OFDMA symbol and N_{used} denotes the total number of subcarriers used to deliver the reference signal. Therefore, the reference signal is transmitted on N_{perSym} subcarriers in each of s OFDMA symbols, and thus eventually on N_{used} subcarriers over the s OFDMA symbols.

The reference signal is added to the data signal on N_{perSym} subcarriers spaced from one another by a preset subcarrier spacing in the frequency band. As noted from Equation (1), a reference signal response across the frequency band is received after s symbols. However, since the reference signal power is less than the data signal power by a factor of x dB, the transmission of s OFDM symbols each having the reference signal on N_{perSym} subcarriers occurs N times to improve the SIR of the reference signal.

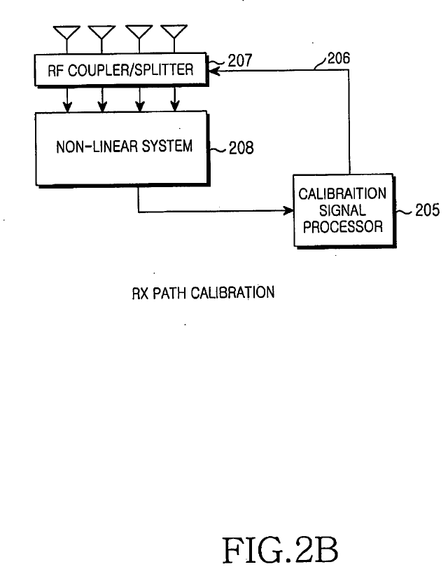

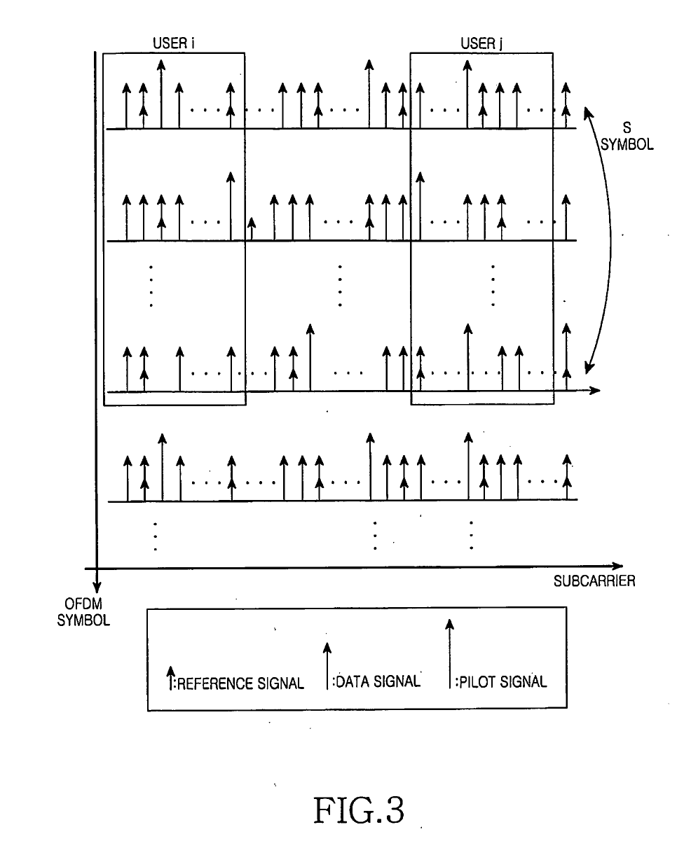

This reference signal transmission method is illustrated in FIG. 3. In accordance with an embodiment of the present invention, the reference signal is transmitted at predetermined subcarriers in s OFDMA symbols and the reference signal transmission in s OFDMA symbols is repeated with a repetition factor of N.

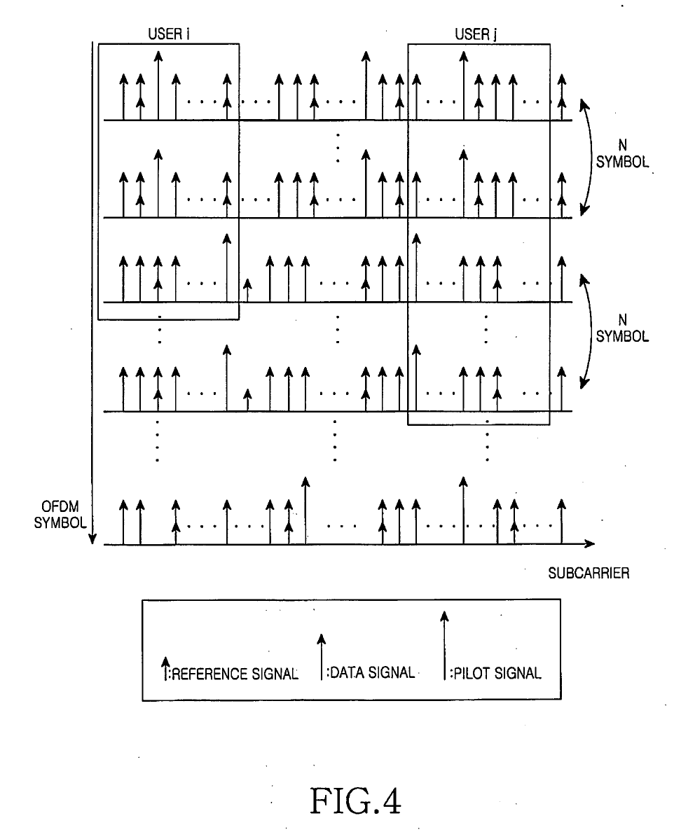

FIG. 4 illustrates a reference signal transmission method according to another embodiment of the present invention. In accordance with the embodiment described in FIG. 4, the reference signal is mapped to N_{perSym} subcarriers spaced from one another by a preset subcarrier spacing in each of N symbols. In N more symbols, the reference signal is transmitted at shifted subcarrier positions. The reference signal transmission in 2N symbols occurs s times.

Both the reference signal transmission methods commonly require the duration of sxN OFDM symbols to receive reference signal responses across the frequency band.

In the case where the reference signal is transmitted every r subcarriers rather than being transmitted across the total frequency band, in order to reduce a calibration operation time, the reference signal responses can be interpolated. Thus, the calibration operation time is decreased by s times according to Equation (1) and eventually, will equal the duration of N OFDMA symbols. For Tx and Rx path calibration, the reference signal is transmitted every r subcarriers, calibration vectors for the used subcarriers are estimated using the reference signal responses, and calibration vectors for the total frequency band are estimated by interpolation.

Now a description will be made of a method of estimating phase and amplitude variations of a signal caused by a non-linear system for each antenna by transmitting a reference signal in the above-described manner, separately for Tx path calibration and Rx path calibration.

The Tx path calibration will first be addressed.

For Tx path calibration, a reference signal is added to a data signal in the above-described reference signal transmission method. The response signals from the non-linear system to the inputs of the sum signals in a Tx path are expressed as Equation (2):

$${Y}_{q , k} = {R}_{q , k} {V}_{q , k} + {\sum }_{l = 1}^{L} {X}_{l , k} {V}_{l , k} \qquad ( 2 )$$

where L denotes the number of antennas, R_{q,k} denotes the reference signal on a k^{th} subcarrier for a q^{th} antenna, X_{1,k} denotes the data signal for each antenna, Y_{q,k} denotes the received response signal of the reference signals and the data signals, V_{q,k} denotes variations in phase and amplitude caused by the non-linear system, and V_{1,k} denotes variations in phase and amplitude on the k^{th} subcarrier for the q^{th} antenna.

Since the reference signal is transmitted at a power level less than the data signal power level by a factor of x dB to avoid the impact of the reference signal transmission on the data signal, the SIR of the reference signal is low, leading to bad estimation performance. Thus, the reference signal is repeated with a repetition factor of N. After N reference signal transmissions, the response signals of the reference signals and the data signals are accumulated. The accumulated response is shown in Equation (3):

$${Y}_{q , k}^{′} = N \cdot {R}_{q , k} {V}_{q , k} + {\sum }_{n = 0}^{N - 1} {\sum }_{l = 0}^{L - 1} {X}_{n , l , k} {V}_{l , k} \qquad ( 3 )$$

Thus, a non-linear system-caused variation in the phase and amplitude of the data signal on the k^{th} subcarrier for the q^{th} antenna in the Tx path is computed by Equation (4):

$${\hat{V}}_{q , k} = {V}_{q , k} + \frac{{\sum }_{n = 0}^{N = 1} {\sum }_{l = 0}^{L - 1} {X}_{n , l , k} {V}_{l , k}}{N \cdot {R}_{q , k}} \qquad ( 4 )$$

As noted from Equation (4), the performance of estimating non-linear system-caused variations in phase and amplitude in the Tx path depends on the number of accumulated symbols. However, the increase of the number of accumulated symbols, N reduces interference in estimates, but increases a calibration operation time. Considering this trade-off relation, N must be appropriately determined. For this purpose, the SIR of the accumulated response described as Equation (3) is computed by Equation (5):

$$SIR = 10 \cdot {log}_{10} ( \frac{N}{L} ) + 10 \cdot {log}_{10} ( \frac{{P}_{R}}{{P}_{X}} ) [ dB ] \qquad ( 5 )$$

where P_{R} denotes the reference signal power and P_{X} denotes the data signal power. To achieve a target SIR while ensuring a certain estimation performance, the sum of the gain resulting from N, 10·log₁₀(N/L) and the power ratio between the reference signal and the data signal, xdB is considered in determining N.

After estimating calibration vectors for all antennas, the calibration vectors are normalized and beamforming weight vectors are calibrated using the normalized calibration vector estimates by Equation (6):

$${\hat{W}}_{l , k} = \frac{{W}_{l , k}}{{C}_{l , k}^{′}} , ( {C}_{l , k} = \frac{{V}_{l , k}}{{V}_{ref , k}} ) \qquad ( 6 )$$

where V_{ref,k} denotes a reference calibration vector among estimated calibration vectors for L antennas. With respect to the reference calibration vector, the calibration vector estimate for each antenna is normalized. Thus, a relative calibration vector C_{1,k} for a k^{th} subcarrier of an 1^{th} antenna is achieved. Then, a beamforming weight vector W_{1,k} is calibrated using the calibration vector C_{1,k}, resulting in a calibrated weight vector Ŵ_{1,k} by which to form a beam pattern in an intended direction.

Rx path calibration is similar to the above-described Tx path calibration, except for a difference in the reference signal power determining method. While calibration is sequentially performed for each antenna in the Tx path calibration, one calibration is commonly applied to all antennas in the Rx path calibration.

In the OFDMA system, downlink data is transmitted with maximum power, whereas uplink data is transmitted with different power in each frame because a BS schedules uplink data transmission. Therefore, the reference signal power cannot be determined for Rx path calibration in the manner that sets the reference signal power to an level x dB less than a constant transmit power in each frame for Tx path calibration. In other words, a reference signal can be transmitted at a power level less than a received power level in one frame but cannot in the next frame.

In accordance with the present invention, a noise power constant in each frame is utilized in determining the reference signal power for use in Rx path calibration. When Rx path calibration begins with an n^{th} frame, a reference signal power level for the n^{th} frame is determined based on an estimate of the noise power of an (n−1)^{th} frame.

Assuming that noise power is constant in every frame, the received response of a k^{th} subcarrier at an 1^{th} antenna is given as Equation (7):
Y_{1,k}=RₖV_{1,k}+Z_{1,k} (7)
where V_{1,k} denotes variations in the phase and amplitude of the k^{th} subcarrier at the 1^{th} antenna, Z_{1,k} denotes a signal received on the k^{th} subcarrier at the 1^{th} antenna, and Rₖ denotes a reference signal on the k^{th} subcarrier. As the reference signal is transmitted for N symbols and its response is accumulated in order to increase its SIR as done in the Tx path calibration, the accumulated response signals of the reference signals and the received signals are expressed as Equation (8):

$${Y}_{l , k}^{′} = N \cdot {R}_{k} \cdot {V}_{l , k} + {\sum }_{n = 1}^{N} {Z}_{l , n , k} \qquad ( 8 )$$

From Equation (8), the SIR of the reference signal is computed by Equation (9):

$$SIR = 10 \cdot {log}_{10} ( N ) + 10 \cdot {log}_{10} \frac{{P}_{R}}{{P}_{Z}} \qquad ( 9 )$$

where P_{R} and P_{Z} denote the reference signal power and the received signal power, respectively. As stated earlier, P_{R} is determined according to P_{R}/P_{N}=x dB in such a way as not to affect the data signal. Here, P_{N} denotes estimated noise power of a frame before Rx path calibration. To improve estimation performance, an accumulation time period N is determined, aiming at a target SIR. SIR and Carrier-to-Interference plus Noise Ratio (CINR) have the same physical meaning and thus they are used interchangeably.

In the OFDMA system, a BS allocates data bursts to subscriber units by scheduling and thus the uplink data rates are determined in relation to a target CINR. With normal power control, a signal from a subscriber unit arrives at the BS with the target CINR and the BS determines the accumulation time period N of Equation (9) based on the CINR. That is, since the BS has knowledge of operating CINRs, the BS determines N using the operating CINR of a Modulation and Coding Scheme (MCS) that affects the reference signal most, to thereby increase the SIR of the reference signal, according to Equation (10):

$$\frac{{P}_{R}}{{P}_{Z}} = \frac{{10}^{xdB / 10}}{N ( {CINR}_{H} + 1 )} = \frac{{10}^{xdB / 10}}{{CINR}_{H} + 1} \qquad ( 10 )$$

where CINR_{H} denotes the CINR of an MCS level that affects the reference signal most seriously. Assuming that the CINR of the MCS level is the lowest, N is determined, which satisfies the target SIR to ensure the estimation performance of variations in phase and amplitude.

Non-linear system-caused variations in the phase and amplitude of a data signal for each antenna in an Rx path are estimated by Equation (11):

$${\hat{V}}_{l , k} = {V}_{l , k} + \frac{{\sum }_{n = 1}^{N} {Z}_{l , n , k}}{N \cdot {R}_{k}} \qquad ( 11 )$$

As described before, for Rx path calibration the reference signal is transmitted at an x dB lower power level than an estimated noise level of a frame before Rx path calibration. Since the BS knows the CINR of a received signal, it determines an accumulation time period N based on the CINR to satisfy a target SIR. Thus, variations in the phase and amplitude of a signal are estimated for each antenna. However, considering that noise power may slightly change between frames, a predetermined margin can be applied to the accumulation time period. After estimating calibration vectors for all antennas, they are normalized and beamforming weight vectors are calibrated using the normalized calibration vectors by Equation (6).

With reference to FIGS. 5 to 8, an apparatus and method for calibrating a smart antenna in Tx and Rx paths are described below.

FIG. 5 is a block diagram of a Tx path calibration apparatus according to an embodiment of the present invention.

Referring to FIG. 5, the Tx path calibration apparatus is comprised of a calibration processor 501 for generating a reference signal to estimate variations in the phase and amplitude of a data signal, transmitting the reference signal to a baseband module 504, receiving a response signal from a non-linear system 507 to the input of the sum of the reference signal and the data signal through a calibration Rx path, demodulating the response signal, and calculating a calibration vector by estimating variations in the amplitude and phase of a signal for each antenna using the demodulated response signal and the reference signal, and the baseband module 504 for receiving the reference signal from the calibration processor 501, adding the reference signal to the data signal, transmitting the sum of the reference signal and the data signal to the non-linear system 507, calibrating a beamforming weight vector using the calibration vector received from the calibration processor 501, and forming a beam using the calibrated beamforming weight vector.

The calibration processor 501 includes a reference signal generator 502 for generating the reference signal for use in estimating the variations in the phase and amplitude of the data signal and transmitting the reference signal to the baseband module 504, a demodulator for demodulating 510 the response signal from the non-linear system 507, and a calibration vector calculator 511 for estimating the variations in the phase and amplitude of the data signal transmitted through each antenna using the response signal and the reference signal. The baseband module 504 includes a reference signal adder 505 for adding the reference signal received from the calibration processor 501 to the data signal and providing the sum to the non-linear system 507 through an OFDMA modulator 506, a beamforming weight vector calibrator 515 for calibrating the beamforming weight vector using the calibration vector received from the calibration processor 501, and a beamformer 516 for forming a beam using the calibrated beamforming weight vector and transmitting the beam to the OFDMA modulator 506 through the reference signal adder 505. The baseband module 504 further includes a beam weight calculator 514 for calculating the beamforming weight vector.

A coupler/combiner 508 provides the response signal through a calibration Rx path 509.

In operation, the reference signal generator 502 of the calibration processor 501 provides a reference signal for an antenna to the reference signal adder 505 of the baseband module 504. The reference signal adder 505 adds the reference signal to a data signal to be transmitted through the antenna. The sum is provided through the OFDMA modulator 506 to a non-linear system 507 corresponding to the antenna. The response of the non-linear system 507 is transmitted to the calibration vector calculator 511 through the coupler/combiner 508 in the calibration Rx path 509. The calibration vector calculator 511 estimates a calibration vector for the antenna by Equation (3) and Equation (4). The above procedure is performed for every antenna. The resulting calibration vectors are normalized and a beamforming weight vector for each antenna is calibrated using the normalized calibration vectors 512 in the weight vector calibrator 515, according to Equation (6). Upper layer (513) is the communication layer that communicates with base station.

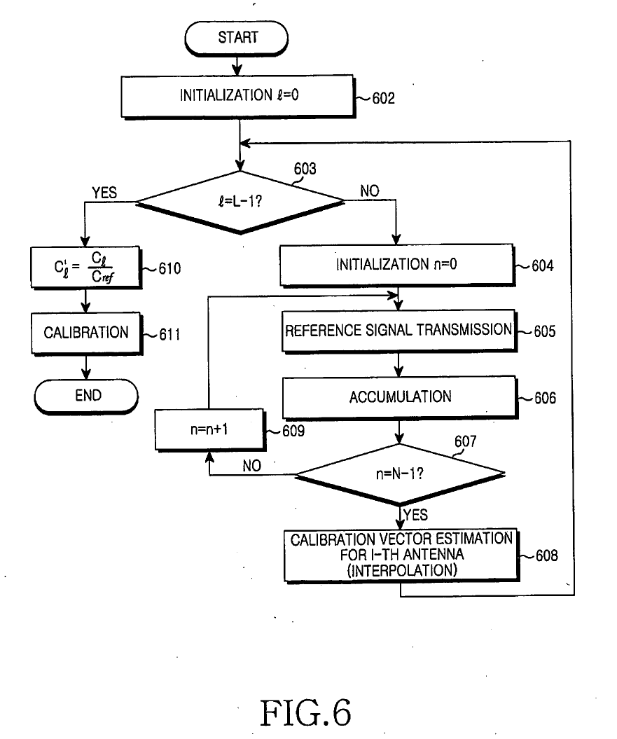

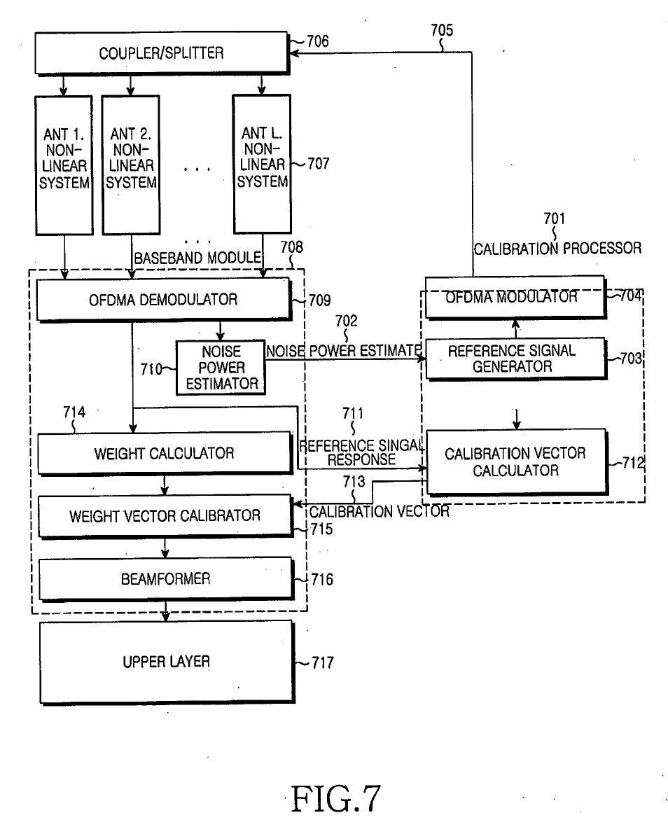

FIG. 6 is a flowchart illustrating a Tx path calibration method according to the embodiment of the present invention. Referring to FIG. 6, number of antenna 1 is initialized 0 in step 602. The number of antenna is reached as L(total number of antennas)−1 in step 603 and then step 610 is performed. In step 604, number of accumulation is initialized 0. A reference signal is transmitted to estimate variations in the phase and amplitude of a signal for each antenna in step 605. As described above, to increase the SIR of the reference signal, the response of the reference signal is accumulated by the calibration vector calculator 511 in step 606. In step 607, the number of accumulation is not reached N, in step 609, the number is increased. In step 608, calibration vectors are estimated using the accumulated response and interpolated, thereby estimating calibration vectors for a total frequency band for a corresponding antenna. After performing this procedure for all antennas, calibration vectors for all antennas are normalized in step 610 and a beamforming weight vector for each antenna is calibrated using the normalized calibration vectors in step 611.

FIG. 7 is a block diagram of an Rx path calibration apparatus according to another embodiment of the present invention.

Referring to FIG. 7, the Rx path calibration apparatus includes a calibration processor 701 for generating a reference signal using a noise power estimate received from a baseband module 708, transmitting the reference signal to a non-linear system 707 after modulation, and calculating a calibration vector by estimating variations in the phase and amplitude of a data signal for each antenna using the reference signal and the response signal from the non-linear system to the input of the reference signal and a signal received through the antenna, and the baseband module 708 for estimating the noise of a frame previous to a frame with which Rx path calibration begins, providing the noise estimate to the calibration processor 701, providing the response of the non-linear system 707 to the calibration processor 701, and calibrating a beamforming weight vector using a calibration vector estimated for the data signal of each antenna, received from the calibration processor 701.

The calibration processor 701 includes a reference signal generator 703 for generating the reference signal based on the noise power estimated by the baseband module 708, an OFDMA modulator 704 for modulating the reference signal and providing the modulated reference signal to the non-linear system 707, and a calibration vector calculator 712 for calculating a calibration vector by estimating variations in the phase and amplitude of the data signal for each antenna. The baseband module 708 includes a noise power estimator 710 for estimating the noise power of a frame previous to a frame with which the Rx path calibration begins and providing the noise power estimate to the calibration processor 701, a beamforming weight vector calibrator 715 for calibrating a beamforming weight vector by a calibration vector received from the calibration processor 701, and a beamformer 716 for forming a beam using the calibrated beamforming weight vector. The baseband module 708 further includes a weight calculator 714 for calculating a beamforming weight vector and an OFDMA demodulator 709. Upper layer (717) is the communication layer, which communicates with base station.

A coupler/splitter 706 transmits the reference signal to the non“-”linear system for each antenna.

In operation, the noise power estimator 710 estimates the noise power of a frame previous to the first Rx path calibration frame. The reference signal generator 703 determines the power of the reference signal based on the noise power estimate 702 and transmits the reference signal to the coupler/splitter 706 through the OFDMA modulator 704 in a calibration Tx path 705. The coupler/splitter 706 provides the reference signal to the baseband module 708 through the non-linear system 707 for each antenna. The reference signal response 711 of the non-linear system 707 is transmitted to the calibration vector calculator 712 through the OFDMA demodulator 709. The calibration vector calculator 712 calculates a calibration vector using the response signal 711 by Equation (7) to Equation (11). The calibration vector for each antenna is normalized and the beamforming weight vector calibrator 715 calibrates a beamforming weight vector for each antenna using the normalized calibration vector 713.

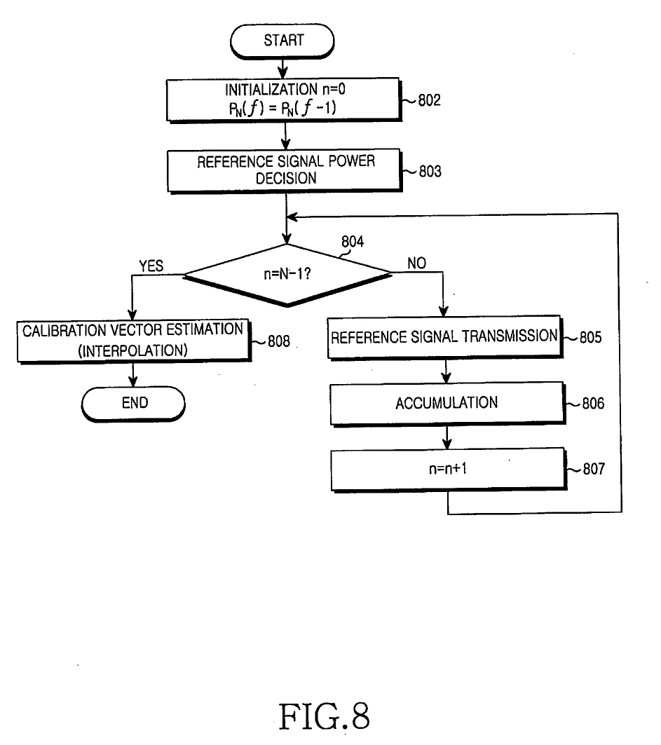

FIG. 8 is a flowchart illustrating an Rx path calibration method according to the second embodiment of the present invention. Referring to FIG. 8, the noise power of a frame previous to the first Rx path calibration frame is estimated and number of accumulation is set 0 in step 802 and reference signal power is determined using the noise power estimate 803. In step 805, a reference signal is transmitted. The response of the reference signal is accumulated in the calibration vector calculator 712 in step 806. The number of accumulation is increased 1 in step 807. Calibration vectors are estimated using the accumulated response signal and interpolated, thereby estimating calibration vectors for a total frequency band for a corresponding antenna in step 808. After estimating calibration vectors for all antennas, the calibration vectors are normalized and a beamforming weight vector for each antenna is calibrated using the normalized calibration vectors.

In accordance with the present invention as described above, signal calibration is carried out in a BS independently of a subscriber unit in an OFDMA system. Since a smart antenna is calibrated without using resources for calibration, resource utilization efficiency is increased. Therefore, the transmission/reception performance of the smart antenna is increased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A multi-antenna communication system, comprising:
a calibration processor for transmitting a reference signal at a power level less than a power level of a data signal to a baseband module, receiving a response signal from a system to the input of a sum of the reference signal and the data signal, modulating the response signal, and calculating a calibration vector by estimating variations in the phase and amplitude of the data signal for each antenna using the reference signal and the response signal; and
a baseband module for receiving the reference signal and adding the reference signal to the data signal, transmitting the sum to the system, calibrating a beamforming weight vector using the calibration vector received from the calibration processor, and forming a beam using the calibrated beamforming weight vector.

2. The multi-antenna communication system of claim 1, wherein the multi-antenna communication system is a multi-antenna multi-carrier communication system.

3. The multi-antenna communication system of claim 1, wherein the calibration processor comprises:
a reference signal generator for generating the reference signal with a power level less than the power level of the data signal, and transmitting the reference signal to the baseband module, for use in estimating variations in the phase and amplitude of the data signal;
a demodulator for demodulating the response signal of the system; and
a calibration vector calculator for estimating variations in the phase and amplitude of the data signal transmitted through each antenna using the demodulated response signal and the reference signal.

4. The multi-antenna communication system of claim 1, wherein the baseband module comprises:
a reference signal adder for adding the reference signal to the data signal and providing the sum to the system through a modulator;
a beamforming weight vector calibrator for calibrating the beamforming weight vector using the calibration vector received from the calibration processor; and
a beamformer for forming a beam using the calibrated beamforming weight vector and providing the beam to the modulator through the reference signal adder.

5. A method of calibrating transmission data in a multi-antenna communication system, comprising the steps of:
transmitting a reference signal at a power level less than a power level of a data signal to a baseband module, for use in estimating system-caused variations in the phase and amplitude of the data signal;
adding the reference signal to the data signal, modulating the sum signal, and transmitting the sum signal to a system;
demodulating a response signal from the system to the sum signal;
accumulating the demodulated response signal;
estimating a calibration vector for the data signal to be transmitted through an antenna using the accumulated response signal; and
calibrating the data signal using the estimated calibration vector.

6. The method of claim 5, wherein the multi-antenna communication system is a multi-antenna multi-carrier communication system.

7. The method of claim 5, wherein the response signal is computed by:
$${Y}_{q , k} = {R}_{q , k} {V}_{q , k} + {\sum }_{l = 1}^{L} {X}_{l , k} {V}_{l , k}$$
where Y_{q,k} denotes the response signal, L denotes the number of antennas, R_{q,k} denotes the reference signal on a k^{th} subcarrier for a q^{th} antenna, X_{1,k} denotes the data signal for each antenna, V_{q,k} denotes system-caused variations in the phase and amplitude of the data signal, and V_{1,k} denotes variations in the phase and amplitude of the data signal on the k^{th} subcarrier for the q^{th} antenna.

8. The method of claim 5, wherein the accumulated response is computed by:
$${Y}_{q , k}^{′} = N \cdot {R}_{q , k} {V}_{q , k} + {\sum }_{n = 0}^{N - 1} {\sum }_{l = 0}^{L - 1} {X}_{n , l , k} {V}_{l , k}$$
where Y′_{q,k} denotes the accumulated response signal, N denotes an accumulation time period, L denotes the number of antennas, R_{q,k} denotes the reference signal on a k^{th} subcarrier for a q^{th} antenna, X_{1,k} denotes the data signal for each antenna, V_{q,k} denotes system-caused variations in the phase and amplitude of the data signal, and V_{1,k} denotes variations in the phase and amplitude of the data signal on the k^{th} subcarrier for the q^{th} antenna.

9. The method of claim 5, wherein the calibration vector estimation step comprises the step of estimating the calibration vector using the accumulated response signal by:
$${\hat{V}}_{q , k} = {V}_{q , k} + \frac{{\sum }_{n = 0}^{N - 1} {\sum }_{l = 0}^{L - 1} {X}_{n , l , k} {V}_{l , k}}{N \cdot {R}_{q , k}}$$
where \hat{V}_{q,k} denotes system-caused variations in the phase and amplitude of the data signal in a transmission path, N denotes an accumulation time period, L denotes the number of antennas, R_{q,k} denotes the reference signal on a k^{th} subcarrier for a q^{th} antenna, X_{1,k} denotes the data signal for each antenna, V_{q,k} denotes system-caused variations in the phase and amplitude of the data signal, and V_{1,k} denotes variations in the phase and amplitude of the data signal on the k^{th} subcarrier for the q^{th} antenna.

10. A multi-antenna communication system, comprising:
a calibration processor for generating a reference signal with a power level less than a power level of a data signal using estimated noise power, transmitting the reference signal to a system after modulation, and calculating a calibration vector by estimating variations in the phase and amplitude of the data signal for each antenna using the reference signal and a response signal from the system to the reference signal; and
a baseband module for generating the estimated noise of a frame previous to a frame at which reception path calibration begins, providing the estimated noise power to the calibration processor, providing the response signal from the system to the calibration processor, and calibrating a beamforming weight vector using the calibration vector received from the calibration processor.

11. The multi-antenna communication system of claim 10, wherein the multi-antenna communication system is a multi-antenna multi-carrier communication system.

12. The multi-antenna communication system of claim 10, wherein the calibration processor, comprises:
a reference signal generator for generating the reference signal with a power level less than the power level of the data signal based on the noise power estimated by the baseband module;
a modulator for modulating the reference signal and providing the modulated reference signal to the system; and
a calibration vector calculator for calculating the calibration vector by estimating variations in the phase and amplitude of the data signal for each antenna.

13. The multi-antenna communication system of claim 10, wherein the baseband module comprises:
a noise power estimator for estimating the noise power of a frame previous to a frame at which the reception path calibration begins and providing the noise power estimate to the calibration processor;
a beamforming weight vector calibrator for calibrating the beamforming weight vector by the calibration vector received from the calibration processor; and
a beamformer for forming a beam using the calibrated beamforming weight vector.

14. A method of calibrating received data in a multi-antenna communication system, comprising the steps of:
determining the power of a reference signal less than a power a data signal using an estimate of the noise power of a frame previous to a frame at which reception path calibration begins;
modulating the reference signal and transmitting the reference signal to a system;
accumulating response signals from the system to the reference signal;
demodulating the accumulated response signals;
estimating a calibration vector for the data signal for an antenna using the demodulated response signals; and
calibrating the data signal using the estimated calibration vector.

15. The multi-antenna communication system of claim 14, wherein the multi-antenna communication system is a multi-antenna multi-carrier communication system.

16. The method of claim 14, wherein the response signals are computed by:
Y_{1,k}=RₖV_{1,k}+Z_{1,k}
where V_{1,k} denotes variations in the phase and amplitude of a k^{th} subcarrier at an 1^{th} antenna, Z_{1,k} denotes a signal received on the k^{th} subcarrier at the 1^{th} antenna, and Rₖ denotes the reference signal on the k^{th} subcarrier.

17. The method of claim 14, wherein the accumulated response signals are computed by:
$${Y}_{l , k}^{′} = N \cdot {R}_{k} \cdot {V}_{l , k} + {\sum }_{n = l}^{N} {Z}_{l , n , k}$$
where N denotes an accumulation time period, V_{1,k} denotes variations in the phase and amplitude of a k^{th} subcarrier at an 1^{th} antenna, Z_{1,k} denotes a signal received on the k^{th} subcarrier at the 1^{th} antenna, and Rₖ denotes the reference signal on the k^{th} subcarrier.
